(19) United States
(12) Patent Application Publication
(10) Pub. No.: US 2023/0375107 A1
(43) Pub. Date: Nov. 23, 2023

(54) PLUMBING ROUTING SYSTEM AND METHOD

(71) Applicant: Paul Jahn, Calgary (CA)

(72) Inventor: Paul Jahn, Calgary (CA)

(21) Appl. No.: 18/364,300

(22) Filed: Aug. 2, 2023

Related U.S. Application Data
(63) Continuation-in-part of application No. 17/817,395, filed on Aug. 4, 2022.
(60) Provisional application No. 63/229,147, filed on Aug. 4, 2021.

(30) Foreign Application Priority Data
Aug. 3, 2022 (CA) 3,169,418

(51) Int. Cl. F16L 3/12; F16L 3/22

(52) U.S. Cl. CPC F16L 3/12; F16L 3/221

(57) ABSTRACT

Systems and methods for routing a plumbing line within a wall include tracks having clip-retaining mechanisms and being attachable within the wall by flexible fins; plumbing-retaining members for gripping the plumbing line and being removably anchored to the clip-retaining mechanisms; and caps and covers removably securable to conceal the plumbing line within the wall.

### CROSS REFERENCE TO RELATED APPLICATIONS

This application claims the benefit of Canadian Patent Application No. 3,169,418 filed on Aug. 3, 2022, which claims benefit to U.S. Provisional Application No. 63/229,147, filed on Aug. 4, 2021. This application also is a continuation-in-part of U.S. Non-Provisional application Ser. No. 17/817,395, filed on Aug. 4, 2022, which also claims benefit to U.S. Provisional Application No. 63/229,147, filed on Aug. 4, 2021. Each of these applications is incorporated herein by reference in its entirety for all purposes.

### FIELD OF THE INVENTION

The present invention is directed to plumbing systems, particularly an improved plumbing routing system and methods of installation and use of same.

### BACKGROUND OF THE INVENTION

Poly B (polybutylene) and Kitec (polymer) plumbing piping were widely used in North America for plumbing supply lines in residential and commercial buildings from 1978 to 1995 (Poly B) and from 1998 to 2007 (Kitec). While polybutylene and polymer were flexible materials, easy to install, and cheaper than copper, significant problems emerged from their use. Since such materials cannot withstand water pressure and heat, residential and commercial buildings with Poly-B or Kitec plumbing were experiencing leaks, causing extensive water damage and mold. Both plumbing systems have failed, leading to class-action lawsuits, and are now subject to scrutiny from insurance companies, making them a primary remediation effort across North America.

However, replacing existing Poly B and Kitec plumbing lines in residential and commercial buildings can be time-consuming and costly. As plumbing lines are often installed inside the walls of buildings, significant demolition is often required to access the plumbing lines, such as the removal of large sections of drywall. Even after the appropriate walls have been removed to access the existing plumbing lines, it can be cumbersome and awkward to remove the lines and install new pipes. The replacement of drywall and finishings, and re-painting incur further costs. Additionally, plumbing replacement procedures typically involve shutting off the water supply for extended periods of time, negatively affecting the comfort of residents and also revenue, in the case of businesses such as hotels.

It is also desirable to install and route new plumbing lines in such a manner so as to make maintenance and replacement easier and less costly, and to avoid the disadvantages of replacing existing plumbing systems.

An alternative process for replacing and/or installing plumbing lines involves installing plumbing lines along the outside of the interior walls of a building and constructing a “bulkhead” along the top of the walls to conceal the plumbing lines and other utilities therein. Such bulkheads typically comprise drywall attached to a box frame made of wood or metal, and are not designed to be easily opened or removed for access to the plumbing lines therein, for example for maintenance purposes.

Other systems comprise discrete retaining clips fixed to the outside surface of a wall, for example by screwing the clips into studs behind the wall or using drywall anchors, to retain plumbing lines. The clips can include a mechanism for securing elongate caps or covers thereto to hide the plumbing lines from sight. However, mounting the clips can be labour intensive, requiring installers to ensure that each clip is level with adjacent clips. Drywall anchors may need to be installed in the event the required spacing of the clips is smaller than the spacing of wall studs. Additionally, depending on the spacing of the clips, the covers may be secured only loosely to the wall, resulting in unsightly gaps between the covers and wall and the potential for the covers to be inadvertently removed from the clips, for example in the event of an impact against the cover. Such impact can also damage the clip since the forces are localized to each clip. While the clips can be mounted closer together, such closer spacing may require the use of drywall anchors, thereby increasing installation time.

Additionally, while it is often desirable for plumbing systems to incorporate leak detection mechanisms such as water sensors, currently water sensors are placed only at strategic locations near fixtures, such as adjacent to toilets or under kitchen sinks, dishwashers, laundry machines, and the like. Water sensors are not conventionally installed within the walls of a building to monitor for leaks along the plumbing lines due to the difficulty of accessing portions of the system located within walls, building framing, and the like.

There remains a need for a system and method for routing new or replacing problematic plumbing lines (such as Poly B and Kitec) to address the insurance epidemic and develop a scalable and cost-effective solution for this problem. In addition, such a system and method ideally permit robust and efficient installation with minimal demolition, allow for future access of plumbing lines for maintenance and repair, and provide leak detection capability along a substantial portion of the system as opposed to only at strategic locations.

### SUMMARY OF THE INVENTION

The present invention relates to improved plumbing routing systems and methods of installation and uses of same. Plumbing routing systems are provided herein for routing plumbing lines such as water supply lines. The plumbing routing systems may be installed with greatly reduced demolition in relation to conventional systems and methods. The systems may also be used to remediate existing plumbing systems by simply disconnecting the existing system from the water supply, installing the new routing system, running the new lines along the new routing system, and connecting the new lines to the water supply.

Broadly, in one aspect, the invention comprises a cap for a wall comprising upper and lower major surfaces, opposing end surfaces, a first curved lateral surface, a second curved lateral surface, and a pair of opposed flexible fins extending outwardly from the lower major surface for removably securing the cap within the wall.

In some embodiments, each fin comprises a shank and a curved barb inwardly facing the shank, or integrally connected to the shank. In some embodiments, the cap further comprises a bow connected between the shanks.

In some embodiments, the cap further comprises one or more tracks comprising one or more clip-retaining mechanisms, and extending outwardly from the lower major surface and positioned between the shanks along a length or portion thereof of the lower major surface.

In some embodiments, the clip-retaining mechanism comprises a groove extending between the opposed end surfaces of the cap, the grooves being defined by a plurality of rails extending outwardly from the lower major surface, each rail being spaced parallel and apart from adjacent rails and defining a pair of rail lips delimiting a slot for removably anchoring a plumbing-retaining member therein.

In another aspect, the invention comprises a method for concealing one or more plumbing lines within a wall using the above cap.

In another aspect, the invention comprises a system for routing one or more plumbing lines within a wall comprising the above cap.

In some embodiments, the system further comprises one or more plumbing-retaining members configured to grip the one or more plumbing lines and to be removably anchored to the one or more clip-retaining mechanisms of the one or more tracks.

In some embodiments, the plumbing-retaining member comprises a clip having a gripping portion for receiving and gripping the plumbing line, and a mounting portion for removably anchoring to the clip-retaining mechanism.

In another aspect, the invention comprises a method of routing one or more plumbing lines within a wall comprising:
removably anchoring one or more plumbing-retaining members configured to grip the one or more plumbing lines to the one or more clip-retaining mechanisms of the above cap;
partially pulling the one or more plumbing lines through an aperture formed within the wall towards the cap, the one or more plumbing-retaining members gripping the one or more plumbing lines; and
snap-fitting the flexible fins of the cap within the wall to removably secure the cap and the one or more plumbing lines within the wall.

In another aspect, the invention comprises a system for routing one or more plumbing lines within a wall comprising:
a main portion comprising one or more tracks comprising one or more clip-retaining mechanisms and a pair of opposed flexible fins for removably securing the main portion within the wall; and
one or more covers configured to be removably secured to the main portion.

In some embodiments, the main portion comprises a base having upper and lower major surfaces, opposing end surfaces, opposed sides, a first lateral surface, a second lateral surface, and the flexible fins extending outwardly from the sides.

In some embodiments, the base supports the one or more tracks comprising the one or more clip-retaining mechanisms for securing one or more plumbing-retaining members configured to grip the one or more plumbing lines and to be removably anchored to the one or more clip-retaining mechanisms.

In some embodiments, the first and second lateral surfaces extend outwardly from the sides and perpendicular to the sides for resting against an outer surface of the wall.

In some embodiments, the flexible fins extend outwardly below the first and second lateral surfaces, the flexible fins being selected from flat or curved fins; fins comprising barbs; or a pair of fins extending upwardly and outwardly from the sides.

In some embodiments, each side comprises a cover-retaining mechanism for removably securing the cover to the main portion.

In some embodiments, the cover-retaining mechanism comprises first and second opposed pairs of top and bottom protrusions which define gaps therebetween for receiving and removably securing the cover, the cover defining notches and curved edges configured to snap fit between the gaps.

In some embodiments, the cover-retaining mechanism comprises opposed side lips defining cover-engaging shoulders for removably securing the cover thereon, the cover defining first and second cover lips defining side lip-engaging shoulders.

In yet another aspect, the invention comprises a method of routing one or more plumbing lines within a wall comprising:
removably securing the above main portion within the wall by snap-fitting the flexible fins through an aperture formed within the wall;
removably anchoring one or more plumbing-retaining members configured to grip the one or more plumbing lines to the one or more clip-retaining mechanisms of the one or more tracks;
snap-fitting the one or more plumbing lines to the one or more plumbing-retaining mechanisms; and
removably securing the cover to the main portion.

Additional aspects and advantages of the present invention will be apparent in view of the description, which follows. It should be understood, however, that the detailed description and the specific examples, while indicating preferred embodiments of the invention, are given by way of illustration only, since various changes and modifications within the scope of the invention will become apparent to those skilled in the art from this detailed description.

### BRIEF DESCRIPTION OF THE DRAWINGS

The invention will now be described by way of an exemplary embodiment with reference to the accompanying simplified, diagrammatic, not-to-scale drawings. In the drawings:

FIG. 1A is a perspective view of a track of an embodiment of the plumbing routing system. FIG. 1B is a side view of the track of FIG. 1A.

FIG. 2 shows perspective views of plumbing-retaining members in the form of various clips.

FIG. 3A is a perspective view of a first embodiment of a cover. FIG. 3B is a side view of the cover of FIG. 3A. FIG. 3C is a perspective view of a second embodiment of the cover of FIG. 3A including strips of conductive material.

FIG. 4A is a perspective view of a third embodiment of a cover. FIG. 4B is a side view of the cover of FIG. 4A.

FIG. 5A is a perspective view of a first embodiment of the plumbing routing system including the track of FIGS. 1A-B, a pipe clip of FIG. 2 gripping the plumbing line, and cover of FIG. 3A-B or 3C, when assembled. FIG. 5B is a side cross-sectional view of the system of FIG. 5A.

FIG. 6A is a perspective view of a second embodiment of the plumbing routing system including the track of FIGS. 1A-B, a crown clip of FIG. 2 gripping the plumbing line, and cover of FIGS. 4A-B, when assembled. FIGS. 6B-C are side cross-sectional views of the system of FIG. 6A including one (FIG. 6B) and two (FIG. 6C) crown clips.

FIG. 7A is a perspective view of an outer corner cover. FIG. 7B is a perspective view of the outer corner cover of FIG. 7A installed on two lengths of track. FIG. 7C is a perspective view of the outer corner cover of FIG. 7B including two covers installed on the two lengths of track.

FIG. 8A is a perspective view of an inner corner cover being installed on two lengths of track. FIG. 8B is a perspective view of the inner corner cover of FIG. 8A including two covers being installed on the two lengths of track.

FIG. 9 is a perspective view of an end cap being installed over a terminal end of an embodiment of the plumbing routing system.

FIG. 10 is a perspective view of the cover of FIG. 3C coupled with a transition cover having electrical connector contacts.

FIG. 11 is a schematic diagram of an electrical circuit of a leak detection system.

FIG. 12 is a side cross-sectional view of components of the leak detection system of FIG. 11.

FIG. 13 is a view of components of a control box having the leak detection system of FIG. 11 and wireless water shutoff valves.

FIGS. 14A-C are side views of various embodiments of caps for concealing plumbing lines within walls. FIG. 14D is a side view of one embodiment of a cap for securing plumbing lines therein and concealing the plumbing lines within walls.

FIG. 15A is a perspective side view of the cap of FIG. 14A being installed over a hole in a wall. FIG. 15B is a side cross-sectional view of the cap of FIG. 14A installed within the wall.

FIGS. 16A-B are perspective side views of the cap of FIG. 14D including the track of FIGS. 1A-B and pipe clips of FIG. 2 for gripping the plumbing lines during assembly within the wall. FIG. 16C is a side cross-sectional view of the cap of FIG. 14D, when assembled within the wall (plumbing lines omitted for clarity).

FIGS. 17A-F are side cross-sectional views of various embodiments of plumbing routing systems comprising main portions including the track of FIGS. 1A-B (clips for gripping the plumbing line omitted for clarity), and corresponding covers for assembly within a wall.

FIG. 18A is a perspective side view of the plumbing routing system of FIG. 17F including the track of FIGS. 1A-B during assembly within the wall. FIGS. 18B-C are side cross-sectional views of the plumbing routing system of FIG. 17F during (FIG. 18B) and after (FIG. 18C) assembly within the wall. FIG. 18D is a perspective side view of the plumbing lines being installed within the pipe clips of FIG. 2.

FIG. 18E is a perspective side view of the cover of FIG. 17F during assembly. FIG. 18F is a side cross-sectional view of the plumbing routing system of FIG. 17F when assembled within the wall (plumbing lines omitted for clarity). FIG. 18G is a side cross-sectional view of the plumbing routing system of FIG. 17F and plumbing lines when assembled within the wall.

### DETAILED DESCRIPTION OF PREFERRED EMBODIMENTS

Before the present invention is described in further detail, it is to be understood that the invention is not limited to the particular embodiments described, as such may, of course, vary. It is also to be understood that the terminology used herein is for the purpose of describing particular embodiments only, and is not intended to be limiting, since the scope of the present invention will be limited only by the appended claims.

Where a range of values is provided, it is understood that each intervening value, to the tenth of the unit of the lower limit unless the context clearly dictates otherwise, between the upper and lower limit of that range and any other stated or intervening value in that stated range is encompassed within the invention. The upper and lower limits of these smaller ranges may independently be included in the smaller ranges is also encompassed within the invention, subject to any specifically excluded limit in the stated range. Where the stated range includes one or both of the limits, ranges excluding either or both of those included limits are also included in the invention.

Unless defined otherwise, all technical and scientific terms used herein have the same meaning as commonly understood by one of ordinary skill in the art to which this invention belongs. Although any methods and materials similar or equivalent to those described herein can also be used in the practice or testing of the present invention, a limited number of the exemplary methods and materials are described herein.

It must be noted that as used herein and in the appended claims, the singular forms “a,” “an,” and “the” include plural referents unless the context clearly dictates otherwise. The term “horizontal” means the orientation of a plane or line that is substantially parallel to the plane of the horizon. The term “vertical” means the orientation of a plane or line that is substantially at a right angle to the horizontal plane. The term “inward” refers to the direction towards a wall, and the term “outward” refers to the direction away from the wall.

The present invention relates to improved plumbing routing systems and methods of installation and uses of same. In some embodiments, the system is installed on the outer surface of walls of a building for which it is desired to install or replace plumbing lines. In some embodiments, the system is installed within a wall of a building for which it is desired to install or replace plumbing lines. In some embodiments, the system may comprise a leak detection system configured to issue an alarm signal to report a leak and/or to close shutoff valves of the plumbing system to prevent further fluid flow through the plumbing lines.

While the system is shown in the figures to be installed horizontally for ease of reference, it is to be understood that the system is configured to be installed either horizontally or vertically, allowing corresponding plumbing lines to be installed either horizontally or vertically.

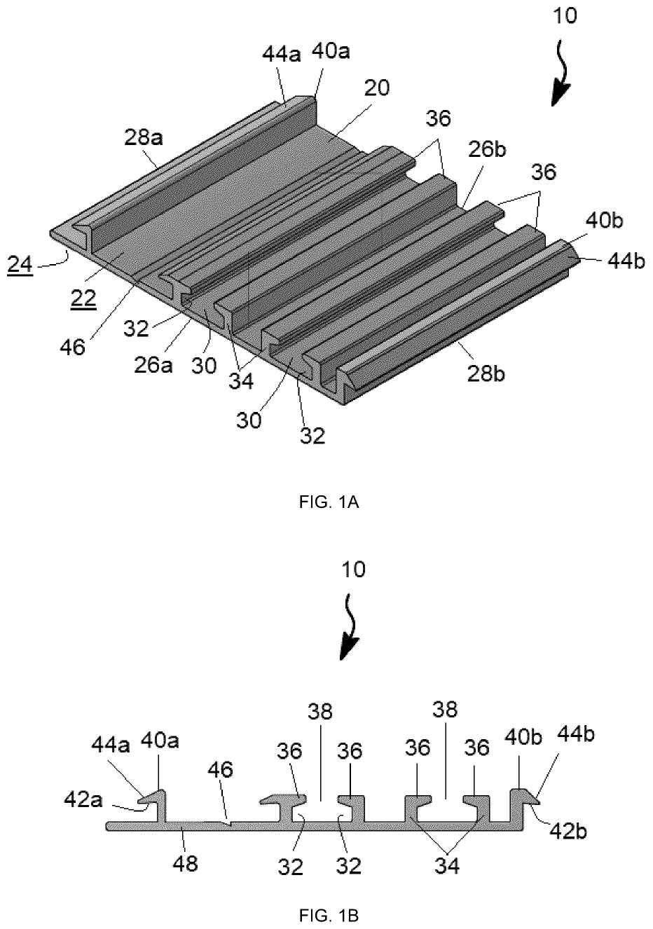

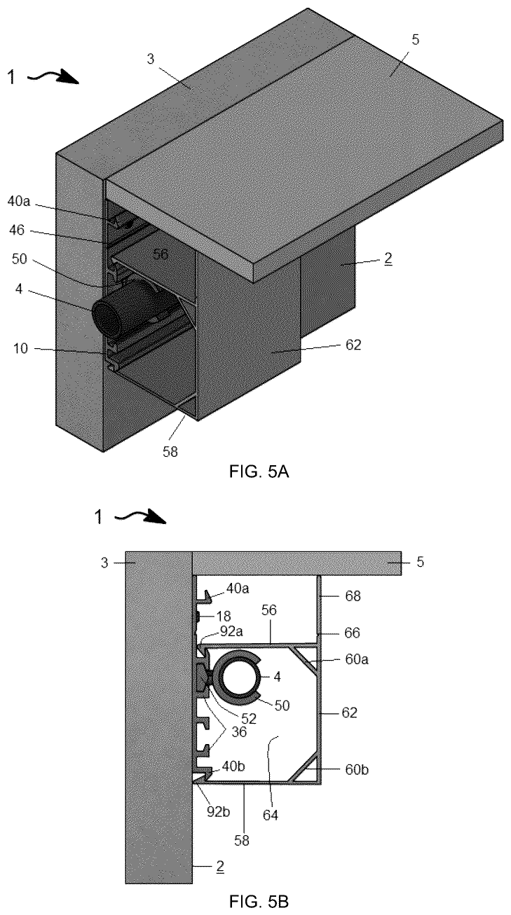

The invention will now be described having reference to the accompanying Figures. In some embodiments, the system is installed on the outer surface of walls of a building for which it is desired to install or replace plumbing lines. The system (1) is shown unassembled in FIGS. 1A-4B and 7A-10 to show all the components in greater detail, and installed and ready for use in FIGS. 5A-6C and 11-13. The system (1) generally comprises the following components: one or more lengths of track (10) which is securable to the outer surface (2) of a wall (3); a plurality of plumbing-retaining members (12) for gripping plumbing lines (4); and a cover (16) for enclosing the track (10), plumbing-retaining members (12), and plumbing lines (4) therein.

As shown in FIGS. 1A-B and 5A-6C, one or more lengths of track (10) are securable to the outer surface (2) of a wall (3) using suitable attachment means (18) including, but not limited to, screws, nails, and the like. Each track (10) comprises a generally flat body (20) having a front surface (22), a back surface (24), opposing first and second ends (26a, 26b), and opposing first and second lengthwise sides (28a, 28b). In some embodiments, the body (20) has a substantially rectangular shape.

The track (10) further comprises a clip-retaining mechanism positioned on the front surface (22) of the body (20) to anchor the plumbing-retaining members (12) to the front surface (22) of the track (10). In some embodiments, the clip-retaining mechanism comprises one or more grooves (30) extending from the first end (26a) to the second end (26b) of the track (10), and defining a clip-anchoring channel (32). In some embodiments, the grooves (30) are formed in the body (20) itself. In some embodiments, the grooves (30) are formed by rails (34). In some embodiments, the rails (34) extend outwardly from the front surface (22) of the body (20). In some embodiments, the rails (34) extend perpendicularly from the front surface (22) of the body (20). The rails (34) are oriented to extend between the opposing first and second ends (26a, 26b) along the entire length of the first and second lengthwise sides (28a, 28b). Each rail (34) is spaced parallel and apart from adjacent rails (34) to form the grooves (30) therebetween for receiving the plumbing-retaining members (12). A pair of rail lips (36) delimit a slot (38) between them for anchoring the plumbing-retaining members (12) within the clip-anchoring channel (32).

The track (10) further comprises a cover-retaining mechanism for coupling a cover (16) to the track (10). In some embodiments, the first portion of the cover-retaining mechanism comprises first and second track lips (40a, 40b) extending lengthwise along the first and second lengthwise sides (28a, 28b) of the track (10). Each of the first and second track lips (40a, 40b) has inward or wall-facing sides (42a, 42b) forming cover-engaging shoulders (44a, 44b). In some embodiments, the first and second track lips (40a, 40b) may include beveled or angled outer edges to facilitate the installation of a cover (16) thereon.

In some embodiments, the track (10) comprises a snap line (46) in the form of a notch to define a removable fin (48). The snap line (46) is positioned proximate and parallel to the first lengthwise side (28a) and extends from the first end (26a) to the second end (26b) of the track (10). The snap line (46) allows the fin (48) to be bent and snapped off along the snap line (46), decreasing the height of the track (10) for use in limited space applications. In some embodiments, the track (10) may be formed of plastic using plastic extrusion or molding processes. In some embodiments, the track (10) may be formed of metal including, but not limited to, galvanized steel, using standard metal smithing processes.

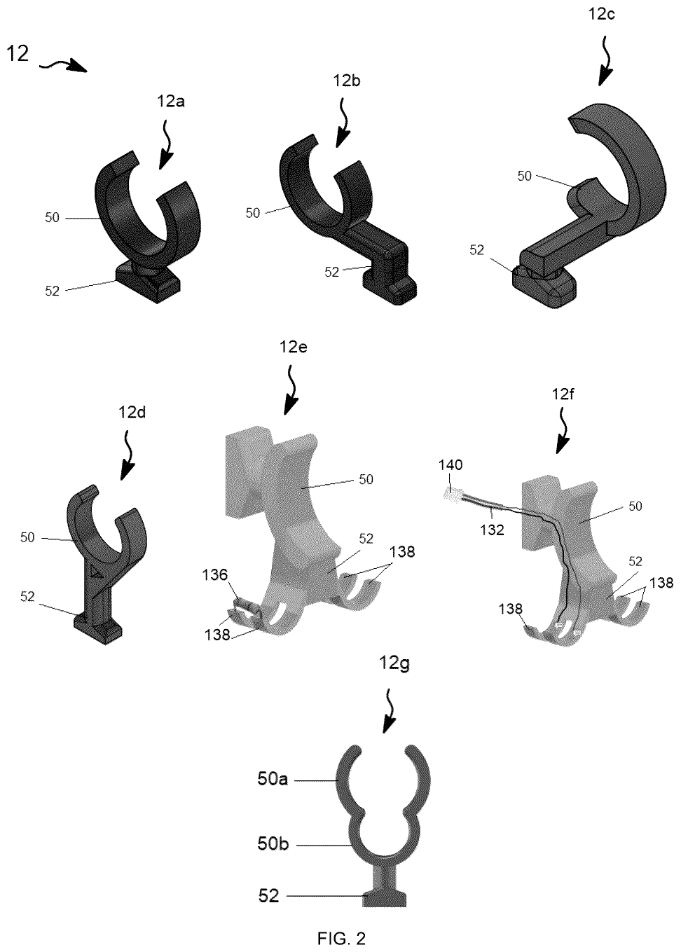

The plumbing-retaining members (12) can be off-the-shelf plumbing securing clips known in the art, or clips configured to couple with the grooves (30) of the tracks (10). As shown in FIG. 2, non-limiting examples of suitable clips include standard pipe holding clips such as, for example, pipe clips (12a) and crown clips (12b), or specialty clips such as, for example, swivel clips (12c), recirc clips (12d), trace clips (12e), trace end clips (12f), and a multi-pipe clip (12g). In some embodiments, the clips (12a-12g) may have a size corresponding to the pipe size ranging from about ¾ inches to about ½ inch. In some embodiments, the multi-size clip (12g) is configured to secure two pipes of different sizes; for example, a first pipe of about ¾ inches and a second pipe of about ½ inch. In some embodiments, the clips (12a-12g) may be formed of plastic using plastic extrusion or molding processes.

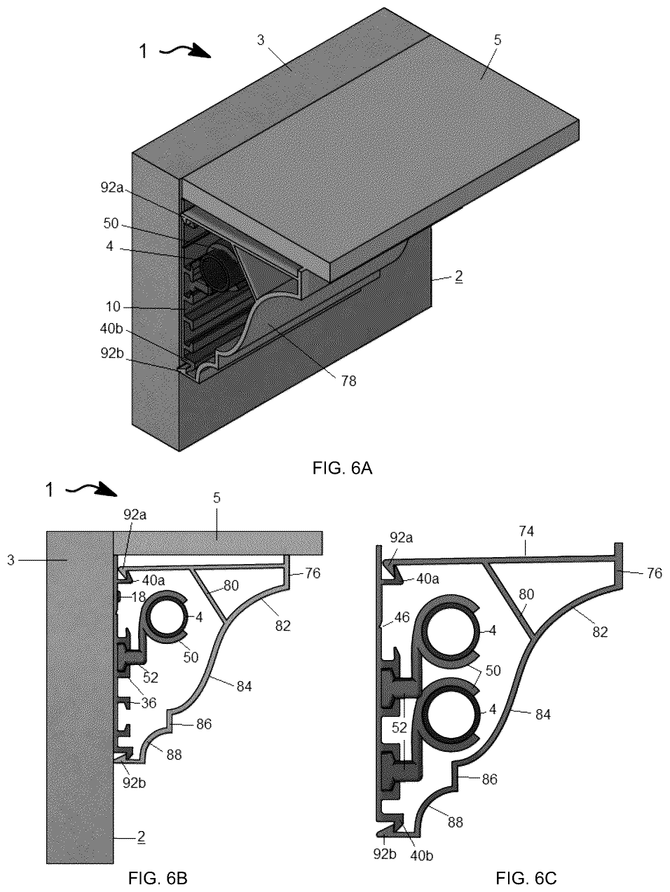

As shown in FIG. 2, each type of clip (12a-12f) generally comprises a gripping portion (50) and a mounting portion (52). The multi-size clip (12g) generally comprises two gripping portions (50a, 50b) and a mounting portion (52). The gripping portion (50, 50a, 50b) is substantially C-shaped to snap-fit around a plumbing line (4). In some embodiments, the gripping portion (50, 50a, 50b) is made of a resilient material so as to be expandable around the plumbing line (4) and grip the plumbing line (4) snugly therein. In some embodiments, the gripping portion (50, 50a, 50b) may be in the form of any suitable strap or clamp known in the art. The mounting portion (52) is substantially T-shaped, having dimensions corresponding to the cross-sectional shape of the rail lips (36) and slot (38) when the clip (for example, 12a, 12b as shown in FIGS. 5A-6C) is in an anchored position where the clip (12a, 12b) is positioned perpendicular to the rails (34), but also allowing the clip (12a, 12b) to be inserted into, or removed from, within the clip-anchoring channel (32) when rotated to an installation position where the clip (12a, 12b) is positioned parallel to the rails (34). To secure a clip (12a, 12b) to the track (10), the mounting portion (52) of the clip (12a, 12b) is rotated to the installation position relative to the selected track groove (30) and inserted into the clip-anchoring channel (32). The clip (12a, 12b) is rotated to the anchored position, at which point the mounting portion (52) of the clip (12a, 12b) and the clip-anchoring channel (32) of the groove (30) cooperate to anchor the clip (12a, 12b) to the track (10).

In some embodiments, other clip-retaining mechanisms can be used to secure the plumbing-retaining members to the tracks. In some embodiments, the body (20) of the track (10) defines apertures for receiving corresponding pegs of the plumbing-retaining members therein.

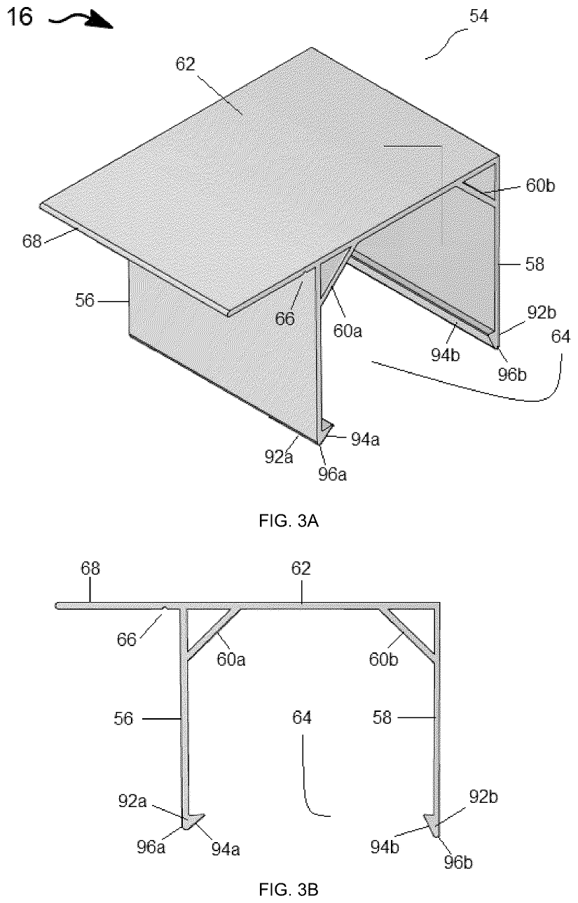

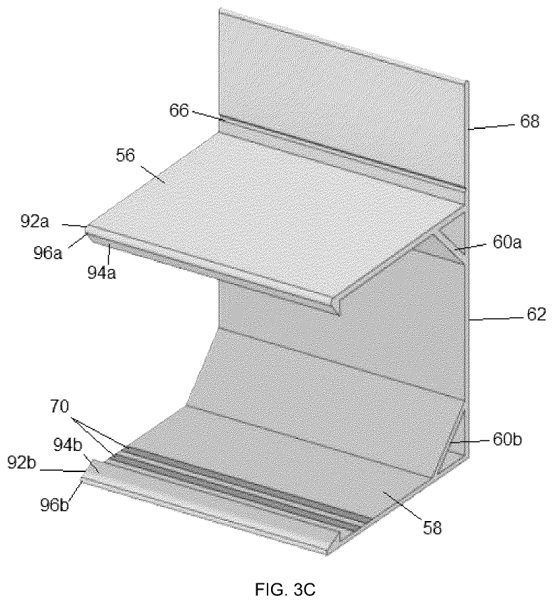

In some embodiments shown in FIGS. 3A-C, the cover (16) comprises a body (54) having a substantially C-shaped axial cross-section. The body (54) comprises a top wall (56), a bottom wall (58), and internal top and bottom supporting braces (60a, 60b) connected to a front wall (62) to define an opening (64) for accommodating and enclosing plumbing lines (4) secured to the track (10) when the cover (16) is coupled with the track (10). In some embodiments, the opening (64) also accommodates standard insulation to provide protection for the plumbing lines (4) from ambient temperature loss and sound attenuation. In some embodiments, the cover (16) is suitable for use with a standard pipe holding clip (12a) as shown in FIGS. 5A-B. The front wall (62) comprises a snap line (66) in the form of a notch to define a removable fin (68). The snap line (66) extends the width of the front wall (62) and allows the fin (68) to be bent and snapped off along the snap line (66), decreasing the height of the cover (16) for use in limited space applications. In some embodiments shown in FIG. 3C, the cover (16) comprises tracing wire (70) installed on the bottom wall (58). In some embodiments, the cover (16) is formed of plastic and/or metal.

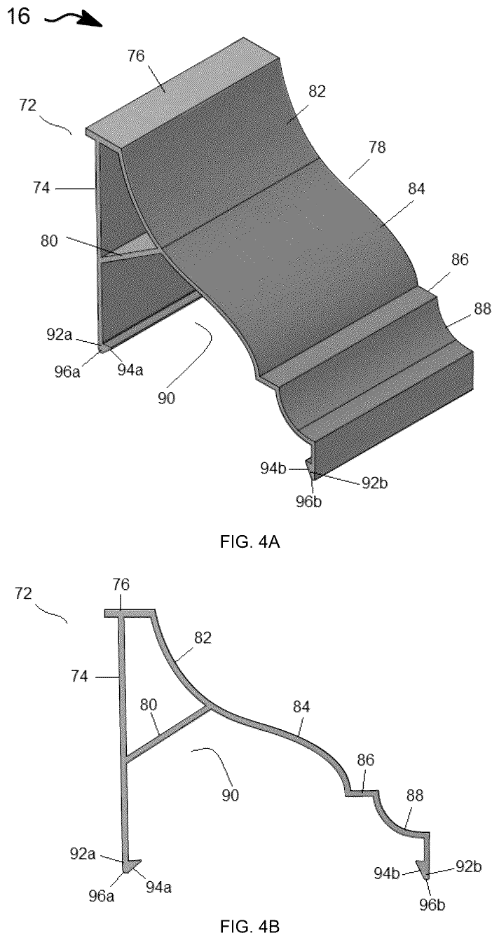

In some embodiments shown in FIGS. 4A-B, the cover (16) comprises a body (72) having a substantially slide-shaped axial cross-section. The body (72) comprises a back wall (74), a top wall (76), and a slide portion (78) connected to the back wall (74) by a supporting brace (80). The slide portion (78) comprises a first concave portion (82), a convex portion (84), a ledge portion (86), and a second concave portion (88). The back wall (74), supporting brace (80), and slide portion (78) define a cavity (90) for accommodating and enclosing plumbing lines (4) secured to the track (10) when the cover (16) is coupled with the track (10). In some embodiments, the cover (16) is suitable for use with a crown clip (12b) since the slide portion (78) provides a sufficiently sized cavity (90) to accommodate the crown clip (12b) (FIGS. 6A-C). In some embodiments shown in FIG. 6C where more than one crown clip (12b) is being used, the bottom crown clip (12b) is installed slightly off-set to the top crown clip (12b) to facilitate its installation. In some embodiments, the cavity (90) also accommodates standard insulation to provide protection for the plumbing lines (4) from ambient temperature loss and sound attenuation. In some embodiments, the cover (16) is formed of plastic and/or metal.

Each of the C-shaped and slide-shaped covers (16) further comprises a second portion of the cover-retaining mechanism for securing the cover (16) to the track (10). As shown in FIGS. 3A-B and 4A-B, the second portion of the cover-retaining mechanism comprises first and second cover lips (92a, 92b) corresponding to first and second track lips (40a, 40b). The first and second cover lips (92a, 92b) each have an outward-facing side (94a, 94b) forming track-engaging shoulders (96a, 96b). In some embodiments, the first and second cover lips (92a, 92b) have beveled or angled outer edges complementary to the beveled or angled outer edges of the first and second track lips (40a, 40b) in order to facilitate installation of the cover (16) to the track (10). In such embodiments, the cover (16) is aligned with the track (10) and pressed thereto. The cover (16) is made of a resilient material such that, when the cover (16) is pressed into the track (10), the first and second cover lips (92a, 92b) flex away from each other as they encounter the first and second track lips (40a, 40b). Once the cover lips (92a, 92b) pass the track lips (40a, 40b), the cover (16) returns to its original shape and the cover lips (92a, 92b) overlap the track lips (40a, 40b), thus retaining the cover (16) to the track (10). In some embodiments, the side walls of the cover (16) can have an overhang over the cover lips (92a, 92b) such that the overhang contacts the wall (3) when the cover (16) is secured to the track (10). Such overhang provides a visually appealing appearance when the cover (16) is secured to the track (10) by preventing apparent gaps between the cover (16) and the wall (3) and mitigating play between the cover (16) and the track (10).

In some embodiments, other cover-retaining mechanisms can be used to secure the covers (16) to the tracks (10). In some embodiments, the covers (16) can be secured to the tracks (10) with fasteners such as screws, or via an interference fit between the covers (16) and the tracks (10).

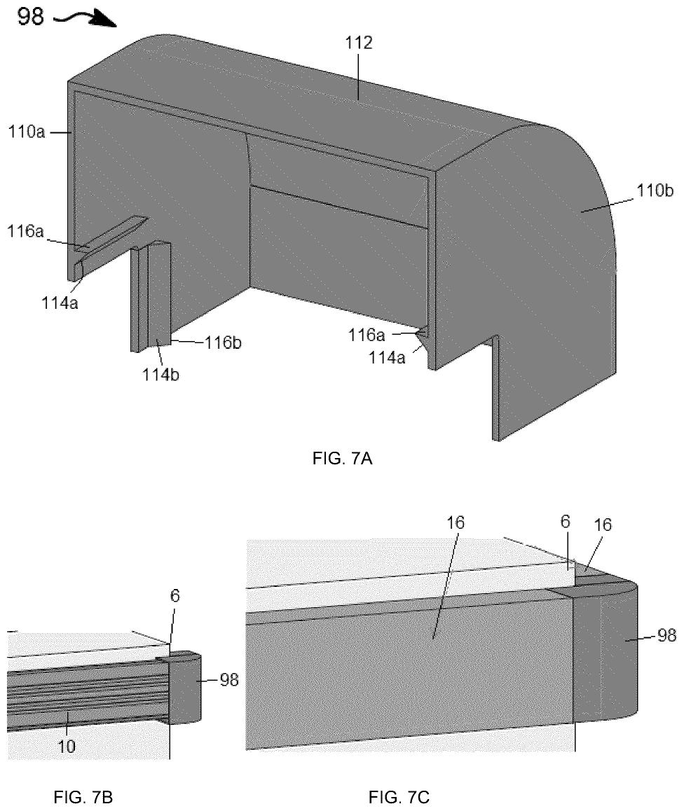

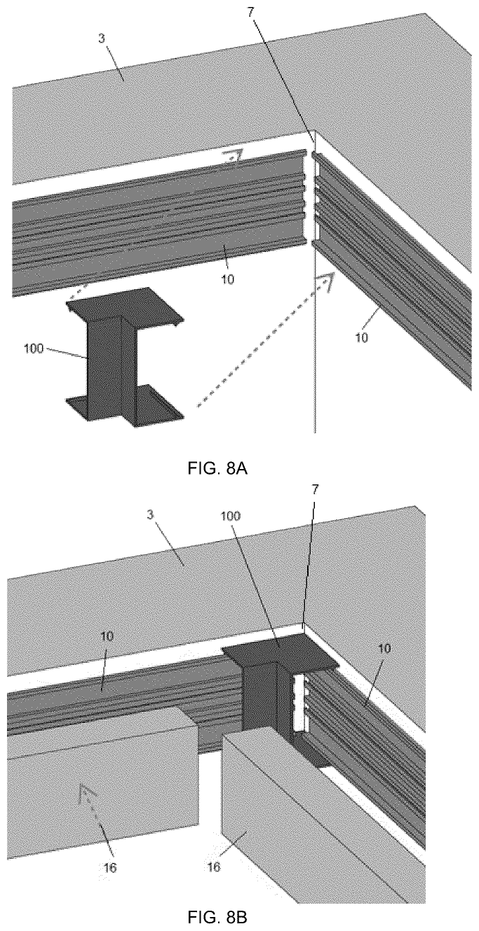

In some embodiments, outer and inner corner covers (98, 100) can be used to enclose plumbing lines (4) at outer (6) or inner corners (7) where two adjacent tracks (10) meet. As shown in FIGS. 7A-C, an outer corner cover (98) for connecting two adjacent lengths of track (10) meeting at an outer corner (6) comprises substantially L-shaped sidewalls (110a, 110b) connected by an outer wall (112). The sidewalls (110a, 110b) comprise a first opposing pair of outer corner lips (114a) located on a first limb (116a) of the sidewalls (110), and a second opposing pair of outer corner lips (114b) located on a second limb (116b) of the sidewalls (110). The first set of outer corner lips (114a) are configured to engage the track lips (40a, 40b) of a first track (10) on a first wall (3), and the second set of outer corner lips (114b) are configured to engage the track lips (40c, 40d) of a second track (10) on a second wall (3) adjacent the first wall (3). In this manner, the outer corner cover (98) can be removably secured to the first and second tracks (10a, 10b) to cover the plumbing lines (4) spanning therebetween. Similarly, as shown in FIGS. 8A-B, the inner corner cover (100) can be used to cover plumbing lines (4) spanning two adjacent lengths of track (10) meeting at an inner corner (7). In some embodiments, the outer or inner corner covers (98, 100) may be formed of plastic using plastic extrusion or molding processes.

As with the covers (16), other mechanisms can be used to retain the corner covers (98, 100) to the tracks (10), including via fasteners such as screws or an interference fit between the corner covers (98, 100) and the tracks (10).

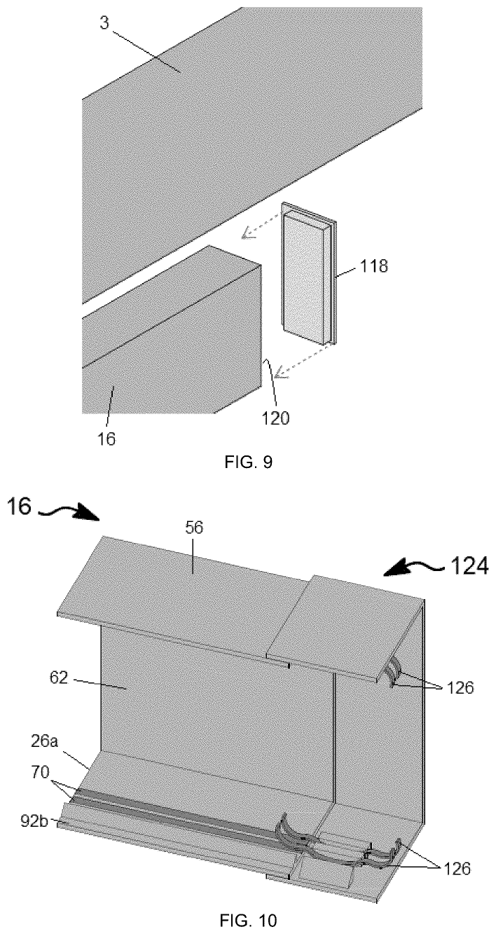

In some embodiments shown in FIG. 9A, end caps (118) can be used to close off terminal ends (120) of the system (1). The end caps (118) are configured to engage with the coupled track (10) and cover (16) located at the terminal end (120). The end caps (118) provide an aesthetically pleasing finish to the system (1), while permitting easy access to the terminal ends (120) thereof.

In some embodiments, the system (1) further comprises a leak detection and mitigation system (122) for determining the presence of a leak and taking the appropriate steps in response such as automatically triggering an alarm and/or shutting off supply to the plumbing lines.

In some embodiments shown in FIGS. 3C and 10, each cover (16) comprises at least one pair of parallel leak detection strips (70) made of an electrically conductive material and running from the first end (26a) to the second end (26b) thereof. Transition covers (124) and the corner covers (98, 100) can each comprise at least one a pair of contact strips (126) configured to contact the detection strips (70) of adjacent covers (16) located on either side of the transition and corner covers (124, 98, 100), such that every cover (16), corner cover (98, 100), and transition cover (124) of the system (1) are electrically connected via their respective detection strips (70) and contact strips (126). In some embodiments, each of the covers (16), corner covers (98, 100), and transition covers (124) has a first pair of strips at a first side and a second pair of strips at a second opposite side.

A controller or central processing unit (“CPU”) (128) is electrically connected to the detection and/or contact strips (70, 126) and configured to detect a voltage change or short across the first and second strips of a pair of strips (70, 126). Such a voltage chance or short is indicative of a leak. For example, in normal operation, there should be no current flowing between the first and second strips of a pair of detection strips/transition strips (70, 126). In the event of a leak, when fluid electrically connects the strips (70, 126), the voltage thereacross should drop to zero or near zero to indicate a short.

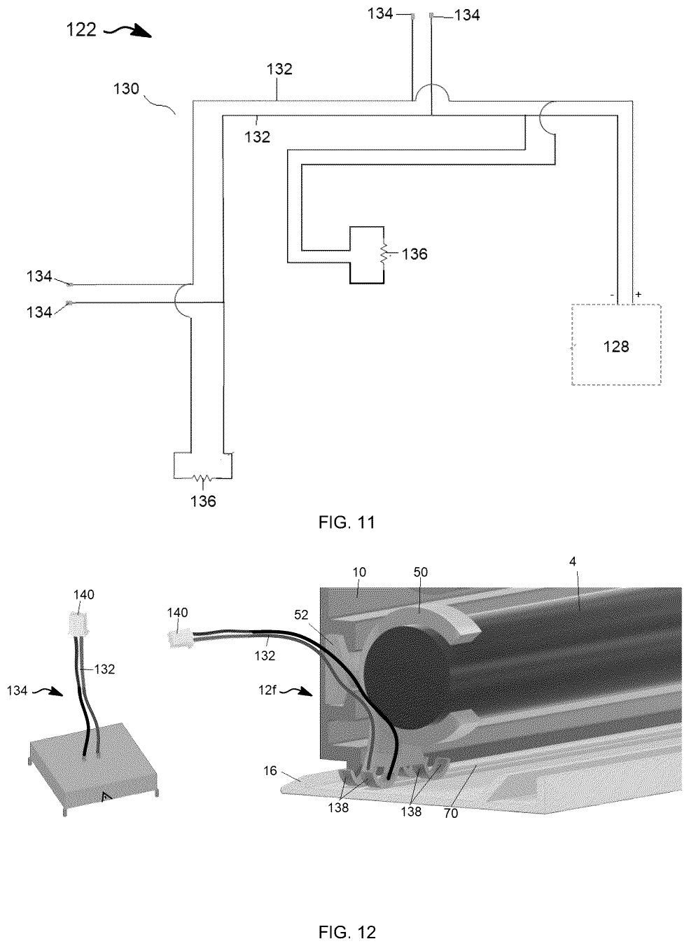

In some embodiments shown in FIG. 11, the electric circuit (130) includes the controller or CPU (128), tracing wires (132), trace puck electrodes (134), and resistors (136). As shown in FIGS. 2 and 12, trace clips (12e) and trace end clips (12f) are positioned on the tracks (10) to grip the plumbing line (4), and also include conductive foil (138) on their legs for contact with the tracing wires (132). The trace clips (12e) include a connector (140) to attach to the trace puck electrodes (134) in the wall (3) or lead back to the controller (128). The trace end clips (12f) include a resistor (136).

The controller (128) sends a low voltage current (for example, ranging between about 12V to about 16V) through the tracing wires (132), which returns after passing through the resistor(s) (136) at the end(s) of the electric circuit (130). A “calibrate” command is activated and the controller (128) records the “calibrated voltage” returned from the resistor(s) (136) compared to the supply voltage. A voltage drop is expected due to ohms law, with the amount of the voltage drop determined by the length of the tracing wire (132). During normal operation, the controller (128) records the returned voltage several times a second and compares it to the calibrated voltage. The voltage drop exceeding a predetermined percentage indicates a leak (i.e., water contacting the system (1)), and triggers valves (142) to shut off the water, preventing further damage. If the voltage reading is zero, the controller (128) determines that there is a break in the tracing wires (132), and activates the valves (142) to shut off the water supply to the plumbing lines (4).

In some embodiments, the controller (128) can issue an alarm signal, such as an audible and/or visual alarm, in response to the detection of a leak. The controller (128) may also be connected to a monitoring system located on-site or off-site, via wired or wireless networks, and indicate a leak to the monitoring system.

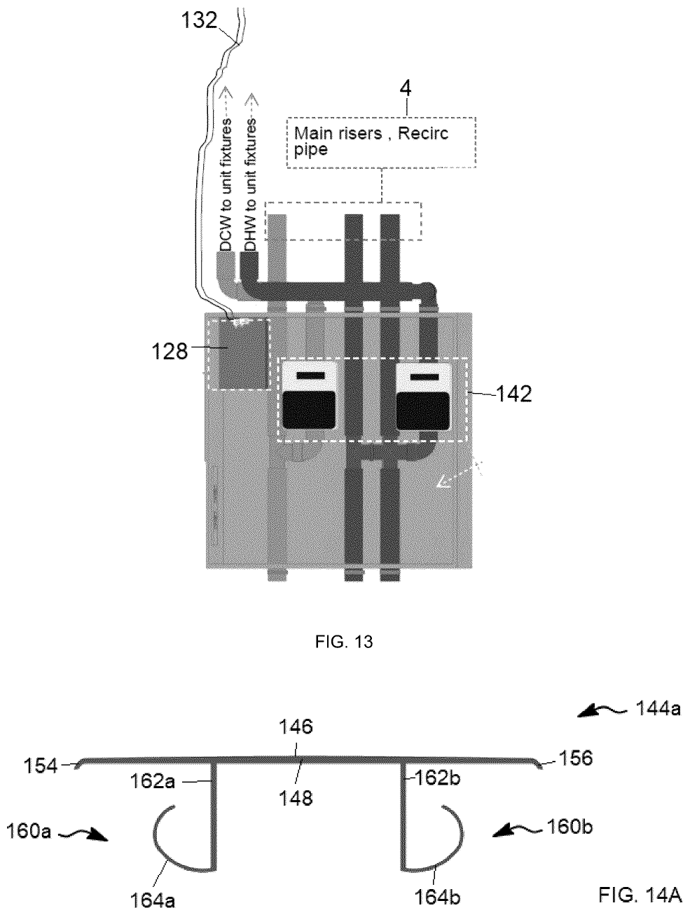

In some embodiments shown in FIG. 13, the controller (128) is connected to shutoff valves (142) of the plumbing system and to instruct the valves (142) to shut off water flow through the plumbing lines (4) in the event of a leak. The controller (128) is connected to the shutoff valves (142) via hardwire connections or via a wireless communications network.

In some embodiments, the detection strips (70) can be located on the tracks (10) as opposed to the covers (16). The detection strips (70) of adjacent tracks (10) can be electrically connected via transition tracks with contact strips similar in design to those of the transition covers (124), or the detection strips (70) of the tracks (10) can have an overhang on the first or second side thereof such that the detection strips (70) of a track (10) overlap and contact the detection strips (70) of a subsequent track (10).

In use, the tracks (10) of the system (1) are installed on the outer surface (2) of the interior walls (3) of a building according to the desired plumbing routing. In some embodiments, the track (10) is installed with the fin (48) in contact as closely as possible with the ceiling (5), even if uneven as with ceiling drywall mud. The tracks (10) are secured to the walls (3) using suitable attachment means (18) including, but not limited to, screws, fasteners, adhesives, and the like. In some embodiments, the attachment means (18) comprise screws driven into wall studs. One or more rows of screws may be used to secure the track (10) and provide additional stability. The plumbing-retaining members (12) are secured to the tracks (10) at the desired locations and intervals, and grip the plumbing lines (4) as shown in FIGS. 5A-B and 6A-C. The covers (16) are installed to enclose the tracks (10), plumbing-retaining members (12), and plumbing lines (4) with transition covers (124) used as appropriate to physically connect, and electrically connect in embodiments having a leak detection system (122), adjacent covers (16). Corner covers (98, 100) are installed at outer and inner corners (6, 7) as appropriate.

Existing plumbing systems can be retrofit or remediated using the system (1) with greatly reduced need to remove drywall and access the previous plumbing lines by simply disconnecting the existing plumbing lines from the water supply and connecting new plumbing lines to the supply. The system (1) can be installed as described above without demolition, and the interiors of walls need to be accessed only to pass the new plumbing lines between rooms/floors if the lines cannot be routed along the exterior of the walls.

In some embodiments, the system is installed within a wall of a building for which it is desired to install or replace plumbing lines. Systems and methods for routing a plumbing line within a wall include the tracks having clip-retaining mechanisms and being attachable within the wall by flexible fins; the plumbing-retaining members for gripping the plumbing line and being removably anchored to the clip-retaining mechanisms; and various embodiments of caps and covers removably securable to conceal the plumbing line within the wall.

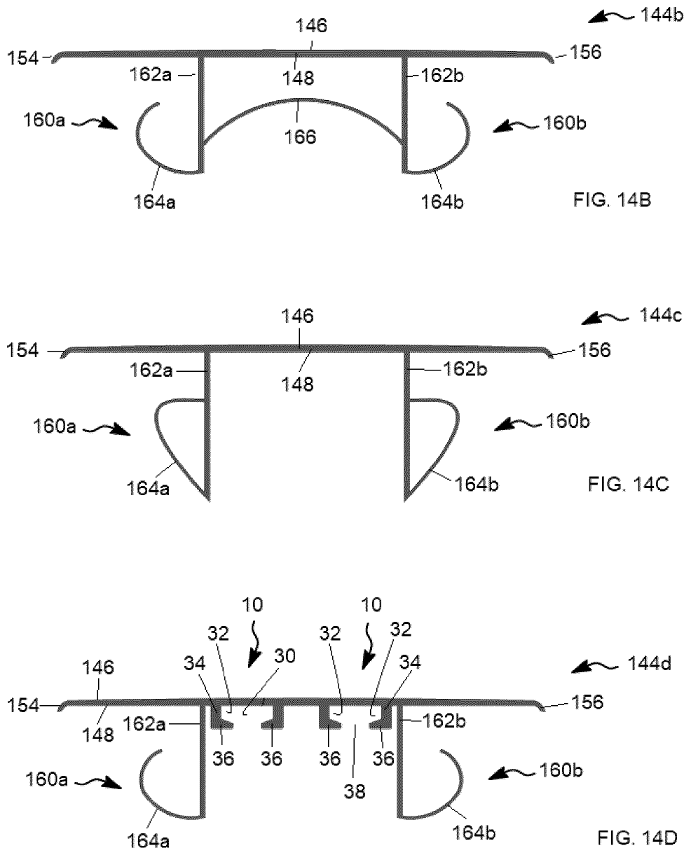

In some embodiments shown in FIGS. 14A-D, a cap (144a-d) for concealing one or more plumbing lines (4), electrical wires, or other utilities within a wall (3) comprises upper and lower major surfaces (146, 148), opposing end surfaces (150, 152), a first curved lateral surface (154), a second curved lateral surface (156), and a pair of opposed fins (160a, 160b) extending outwardly from the lower major surface (148) for removably securing the cap (144a-d) within the wall (3). In some embodiments, the fins (160a, 160b) extend between the opposing end surfaces (150, 152) and along the length or portion thereof of the lower major surface (148).

The fins (160a, 160b) may vary in configuration. In some embodiments, each fin (160a, 160b) comprises a shank (162a, 162b) and a curved barb (164a, 164b) inwardly facing the shank (162a, 162b). In some embodiments (144c), the barb (164a, 164b) is integrally connected to the shank (162a, 162b) (FIG. 14C). In some embodiments, the fins (160a, 160b) are flexible. In some embodiments, the fins (160a, 160b) are formed of plastic. In some embodiments, the cap (144b) includes a bow (166) connected between the shanks to provide stability (162a, 162b) (FIG. 14B).

In some embodiments, the cap (144d) comprises one or more lengths of track (10) comprising one or more clip-retaining mechanisms and extending outwardly from the lower major surface (148) and positioned between the shanks (162a, 162b) along the length or portion thereof of the lower major surface (148) (FIG. 14D).

The cap (144a-d) may vary in size and shape to be insertable into an aperture (8) within the wall (3). The cap (144a-d) may be cut to a size and shape to align properly with the aperture (8). In some embodiments, the cap (144a-d) has a substantially rectangular shape. In some embodiments, the cap (144a-d) has a substantially square shape. In some embodiments, the cap (144a-d) is flexible. In some embodiments, the cap (144a-d) is formed of plastic.

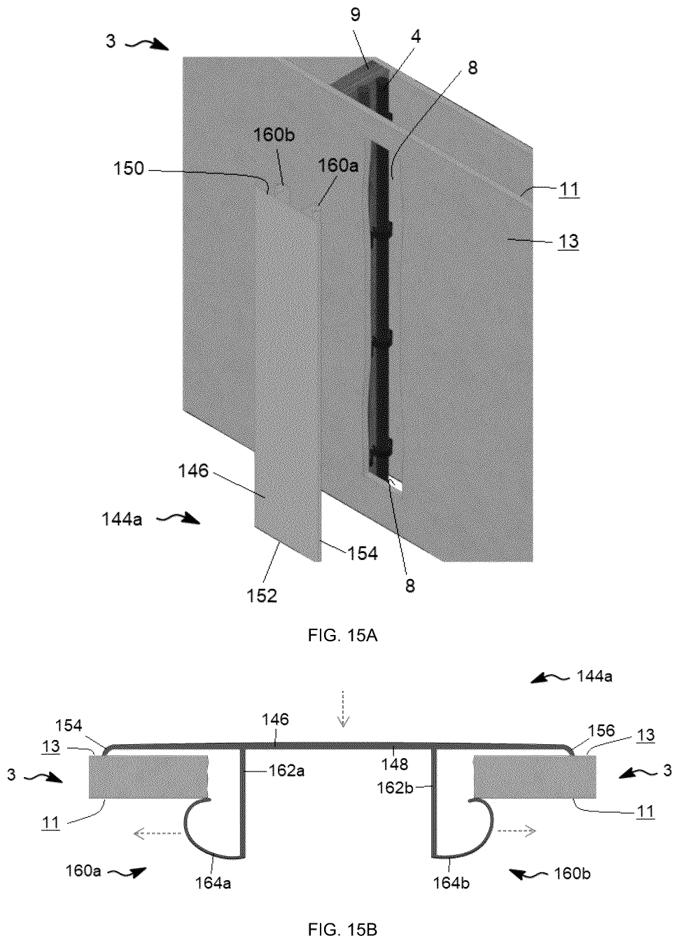

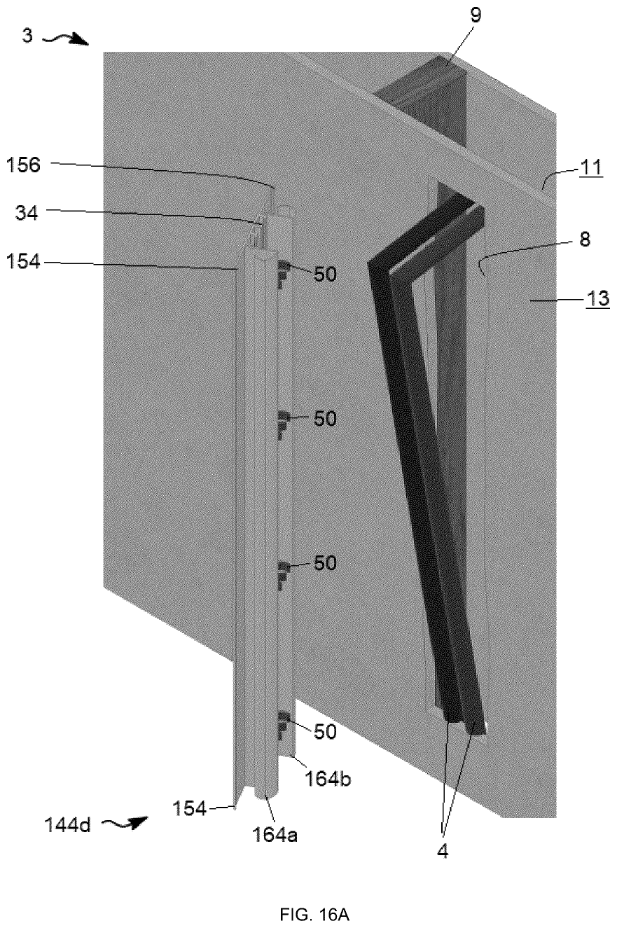

In some embodiments, a method for concealing plumbing lines (4), electrical wires, or other utilities within the wall (3) comprises removably securing any of the above caps (144a-c) within the wall (3). In some embodiments shown in FIGS. 15A-B, an aperture (8) is cut into the wall (3) proximate to the plumbing lines (4), electrical wires, or other utilities secured to the wall stud (9) using suitable attachment means (including, but not limited to, “C” nail-in clamps) inside the wall (3), and allowing sufficient space for insertion of the cap (144a-c). The first barb (164b) of the cap (144a-c) is inserted into the aperture (8) to allow the first barb (164b) to flex inwardly, and the second barb (164a) is then snap-fit into the aperture (8) such that the first and second barbs (164a, 164b) flex outwardly (shown by arrows) to press against the inner surface (11) of the wall (3), thereby securing the cap (144a-c) within the wall (3). The first and second curved lateral surfaces (154, 156) rest against the outer surface (13) of the wall (3). The upper major surface (146) of the cap (144a-c) can be painted to match the color of the wall (3), thereby concealing the cap (144a-c) for aesthetic purpose.

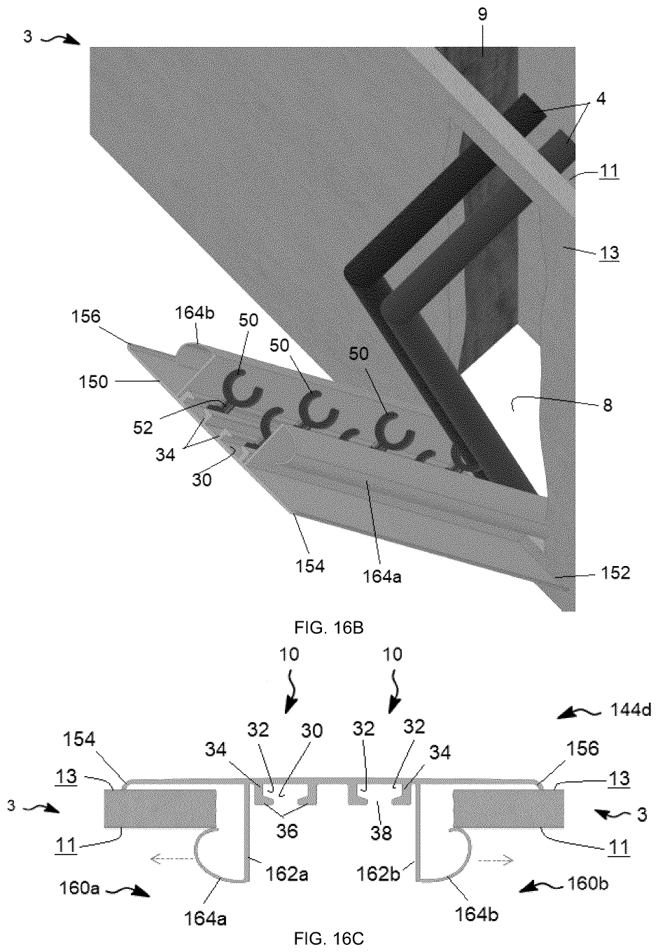

In some embodiments, a system and method for routing plumbing lines (4), electrical wires, or other utilities within a wall (3) comprises removably securing the cap (144d) comprising one or more tracks (10) within the wall (3). In some embodiments as shown in FIGS. 16A-C where the cap (144d) comprises one or more lengths of track (10), an aperture (8) is cut into the wall (3). The plumbing line (4), electrical wire, or other utilities are loosely installed within the wall (3). The track (10) comprises clip-retaining mechanisms positioned on the lower major surface (148) to anchor the plumbing-retaining members (12) to the track (10). In some embodiments, the clip-retaining mechanism comprises one or more grooves (30) extending between the opposing end surfaces (150, 152), and defining clip-anchoring channels (32) (FIG. 16C). In some embodiments, the grooves (30) are formed by rails (34). In some embodiments, the rails (34) extend outwardly from the lower major surface (148). In some embodiments, the rails (34) extend perpendicularly from the lower major surface (148). The rails (34) are oriented to extend between the opposing end surfaces (150, 152). Each rail (34) is spaced parallel and apart from adjacent rails (34) to form the grooves (30) therebetween for receiving the plumbing-retaining members (12). A pair of rail lips (36) delimit a slot (38) between them for anchoring the plumbing-retaining members (12) within the clip-anchoring channel (32).

As previously described and shown in FIG. 2, the plumbing-retaining members (12) can be clips (12a-g) generally comprising gripping portions (50) and mounting portions (52). To secure a clip (12a-g) to the track (10), the mounting portion (52) of the clip (12a-g) is rotated to the installation position relative to the selected track groove (30) and inserted into the clip-anchoring channel (32). The clip (12a-g) is rotated to the anchored position, at which point the mounting portion (52) of the clip (12a-g) and the clip-anchoring channel (32) of the groove (30) cooperate to anchor the clip (12a-g) to the track (10).

In some embodiments, a method of routing one or more plumbing lines (4) within a wall (3) comprises removably anchoring one or more plumbing-retaining members (12) configured to grip the one or more plumbing lines (4) to the one or more clip-retaining mechanisms (12a-g) of the cap (144d); partially pulling the one or more plumbing lines (4) through an aperture (8) formed within the wall (3) towards the cap (144d), the one or more plumbing-retaining members (12a-g) gripping the one or more plumbing lines (4); and snap-fitting the flexible fins (160a, 160b) of the cap (144d) within the wall (3) to removably secure the cap (144d) and the one or more plumbing lines (4) within the wall (3).

As shown in FIGS. 16A-C, the track (10) and clips (12a shown as an example) are placed into alignment with the aperture (8) and the plumbing line (4), electrical wire, or other utilities are pulled towards the clips (12a) to allow the clips (12a) to grip the plumbing line (4), electrical wire, or other utilities snugly therein. The first barb (164b) of the cap (144d) is inserted into the aperture (8) to allow the first barb (164b) to flex inwardly, and the second barb (164a) is then snap-fit into the aperture (8) such that the first and second barbs (164a, 164b) flex outwardly (shown by arrows) to rest against the inner surface (11) of the wall (3) and the first and second curved lateral surfaces (154, 156) rest against the outer surface (13) of the wall (3). The upper major surface (146) of the cap (144d) can be painted to match the color of the wall (3), thereby concealing the cap (144d) for aesthetic purpose.

In some embodiments, a system for routing one or more plumbing lines (4) within a wall (3) comprises a main portion (168) comprising one or more tracks (10) comprising one or more clip-retaining mechanisms (12a-g) and a pair of opposed flexible fins (160a, 160b) for removably securing the main portion (168) within the wall (3); and one or more covers (170) configured to be removably secured to the main portion (168).

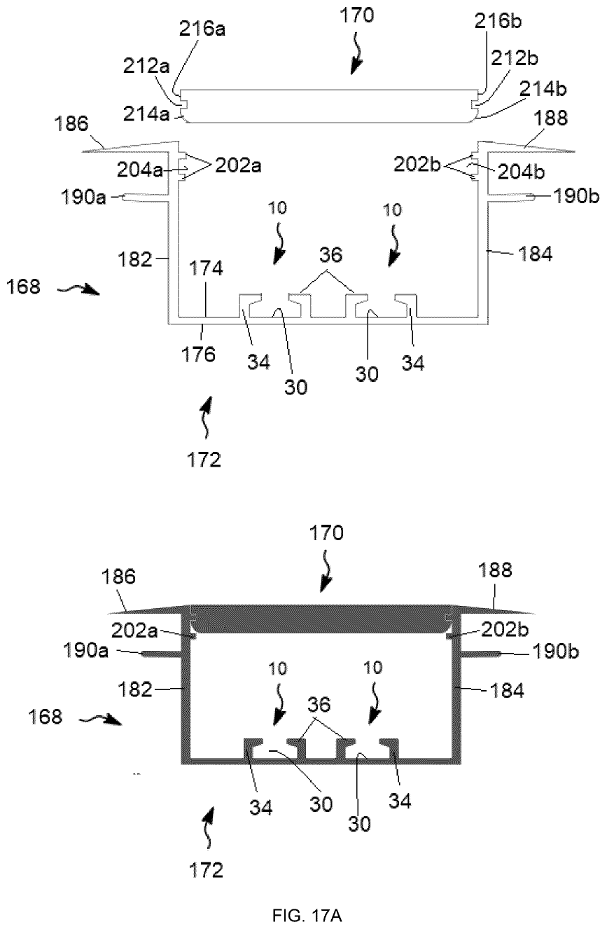

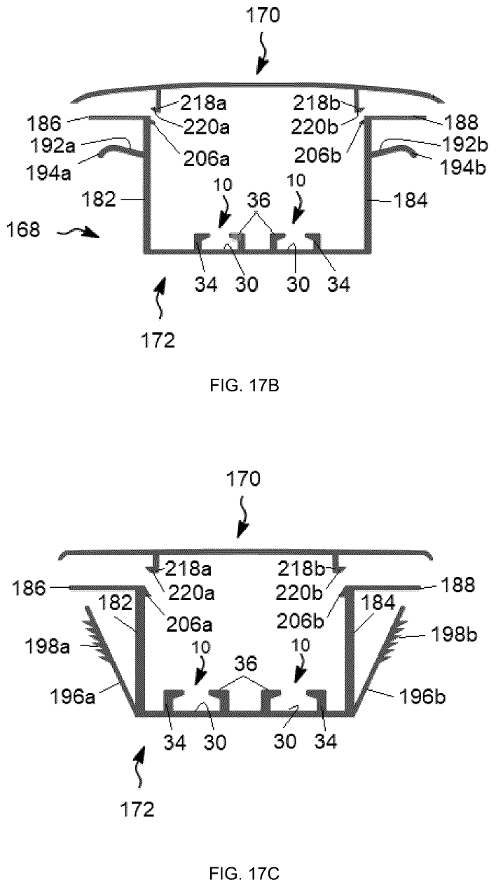

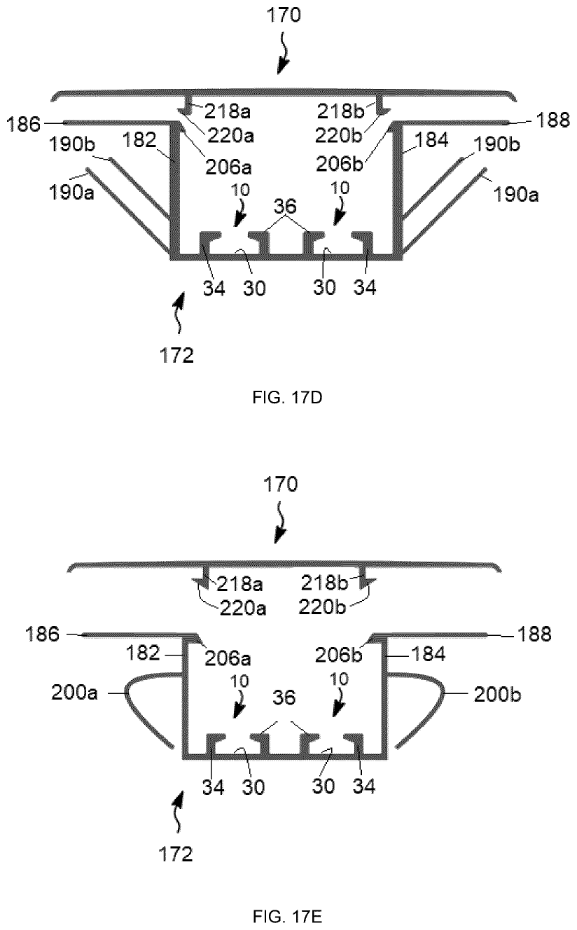

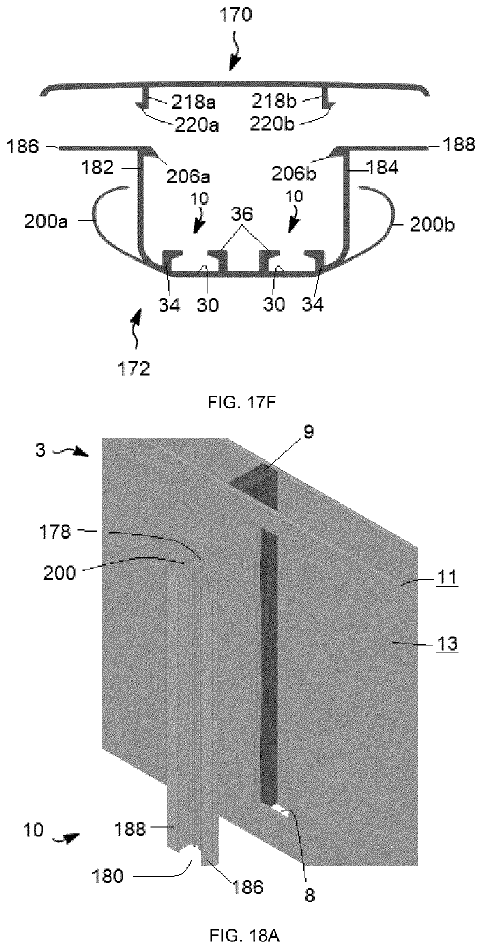

In some embodiments shown in FIGS. 17A-F, a system for routing a plumbing line (4) within a wall (3) comprises a main portion (168) and a cover (170) configured to be removably secured to the main portion (168) for enclosing the track (10), plumbing-retaining members (12), and plumbing lines (4) therein. The main portion (168) and cover (170) may vary in size and shape to be insertable into an aperture (8) within the wall (3). The main portion (168) and cover (170) may be cut to a size and shape to align properly with the aperture (8). In some embodiments, the main portion (168) may be cut to a size and shape identical to or smaller than the aperture (8). In some embodiments, the main portion (168) has a substantially rectangular shape. In some embodiments, the main portion (168) has a substantially square shape. In some embodiments, the main portion (168) and cover (170) are flexible. In some embodiments, the main portion (168) and cover (170) are formed of plastic.

In some embodiments, the main portion (168) comprises a base (172) having upper and lower major surfaces (174, 176), opposing end surfaces (178, 180), opposed sides (182, 184), a first lateral surface (186), a second lateral surface (188), and a pair of opposed fins (190a, 190b) extending outwardly from the sides (182, 184).

In some embodiments, the base (172) is flat (FIGS. 17A-E). In some embodiments, the base (172) has curved edges (FIG. 17F). The base (172) supports one or more tracks (10) comprising one or more clip-retaining mechanisms for securing one or more plumbing-retaining members (12) configured to grip the plumbing lines (4), electric wires, or other utilities and to be removably anchored to the one or more clip-retaining mechanisms.

The first and second lateral surfaces (186, 188) extend outwardly from the sides (182, 184) and perpendicular to the sides (182, 184) for resting against the outer surface (13) of the wall (3). In some embodiments, the first and second lateral surfaces (186, 188) are sloped or have substantially triangular-shaped cross-sections (FIG. 17A). In some embodiments, the first and second lateral surfaces (186, 188) are flat or have substantially rectangular-shaped cross-sections (FIGS. 17B-F).

The fins (190a, 190b) extend outwardly below the first and second lateral surfaces (186, 188) for attaching the main portion (168) within the wall (3). In some embodiments, the fins (190a, 190b) are flexible. In some embodiments, the fins (190a, 190b) are formed of plastic.

The fins (190a, 190b) may vary in configuration. In some embodiments, the fins (190a, 190b) are flat or have substantially rectangular cross-sections (FIG. 17A). In some embodiments, the fins (190a, 190b) are positioned at upward angles relative to the sides (182, 184) and comprise shafts (192a, 192b) and curved tips (194a, 194b). In some embodiments, the fins (190a, 190b) extend upwardly and outwardly at an angle from the intersection of the base (172) and side (182, 184). The fins (190a, 190b) comprise a shaft (196a, 196b) and a plurality of barbs (198a, 198b) (FIG. 17C). In some embodiments, a pair of fins (190a, 190b) are provided (FIG. 17D). A first fin (190a) extends upwardly and outwardly at an angle from the intersection of the base (172) and side (182, 184). A second fin (190b) is positioned between the first or second lateral surface (186, 188) and the first fin (190a), and extends upwardly and outwardly at an angle from the side (182, 184) but parallel to the first fin (190a). In some embodiments, the fins (190a, 190b) comprise barbs (200a, 200b) which point downwardly towards the intersection of the base (172) and sides (182, 184) (FIG. 17E). In some embodiments, the fins (190a, 190b) comprise barbs (200a, 200b) which extend upwardly from curved edges of the base (172), and point towards the sides (182, 184) (FIG. 17F).

Each side (182, 184) comprises a cover-retaining mechanism for securing the cover (170) to the main portion (168). In some embodiments, the cover-retaining mechanism comprises first and second opposed pairs of top and bottom protrusions (202a, 202b) which define gaps (204a, 204b) therebetween for receiving and removably securing the cover (170) (FIG. 17A). In some embodiments, the cover-retaining mechanism comprises opposed side lips (206a, 206b) defined at the intersections of the sides (182, 184) and the first and second lateral surfaces (186, 188) (FIGS. 17B-F). The side lips (206a, 206b) have base-facing sides forming cover-engaging shoulders. In some embodiments, the side lips (206a, 206b) have beveled or angled outer edges to facilitate installation of the cover (170) thereon.

The covers (170) may vary in configuration. In some embodiments, the cover (170) is substantially rectangular-shaped in cross-section and defines notches (212a, 212b) and curved edges (214a, 214b) at its sides (216a, 216b) so as to be received and removably snap fit within the gaps (204a, 204b) formed by the top and bottom protrusions (202a, 202b) (FIG. 17A). In such an embodiment, the cover (170) is aligned with the main portion (168) and pressed thereto. In some embodiments, the cover (170) is made of a resilient material. When the cover (170) is pressed into the main portion (168), the notches (212a, 212b) engage the top protrusions (202a, 202b) and the curved edges (214a, 214b) rest between the top and bottom protrusions (202a, 202b), thus retaining the cover (170) to the main portion (168).

In some embodiments, the cover (170) is substantially curved in cross-section (FIG. 17B). In some embodiments, the cover (170) is substantially flat (FIGS. 17C-F). In some embodiments, the cover (170) defines first and second cover lips (218a, 218b) having outwardly facing sides forming side lip-engaging shoulders (220a, 220b) (FIGS. 17B-F). In some embodiments, the cover lips (218a, 218b) have beveled or angled outer edges complementary to the beveled or angled outer edges of the first and second side lips (206a, 206b) to facilitate installation of the cover (170) to the main portion (168). In such embodiments, the cover (170) is aligned with the main portion (168) and pressed thereto. The cover (170) is made of a resilient material such that, when the cover (170) is pressed into the main portion (168), the cover lips (218a, 218b) flex inwardly as they encounter the side lips (206a, 206b). Once the cover lips (218a, 218b) pass the side lips (206a, 206b), the cover (170) returns to its original shape and the cover lips (218a, 218b) overlap the side lips (206a, 206b), thus retaining the cover (170) to the main portion (168).

In some embodiments, a method of routing one or more plumbing lines (4) within a wall (3) comprises removably securing the main portion (168) within the wall (3) by snap-fitting the flexible fins (190a, 190b) through an aperture (8) formed within the wall (3); removably anchoring one or more plumbing-retaining members (12) configured to grip the one or more plumbing lines (4) to the one or more clip-retaining mechanisms of the one or more tracks (10); snap-fitting the one or more plumbing lines (4) to the one or more plumbing-retaining mechanisms (12); and removably securing the cover (170) to the main portion (168).

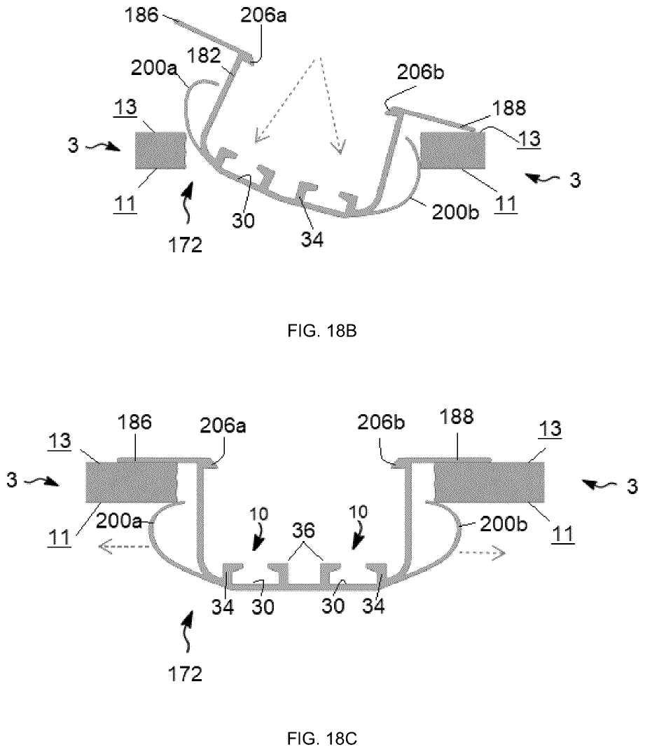

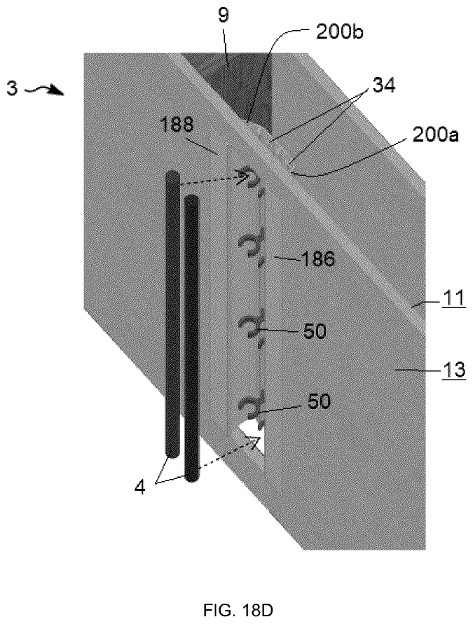

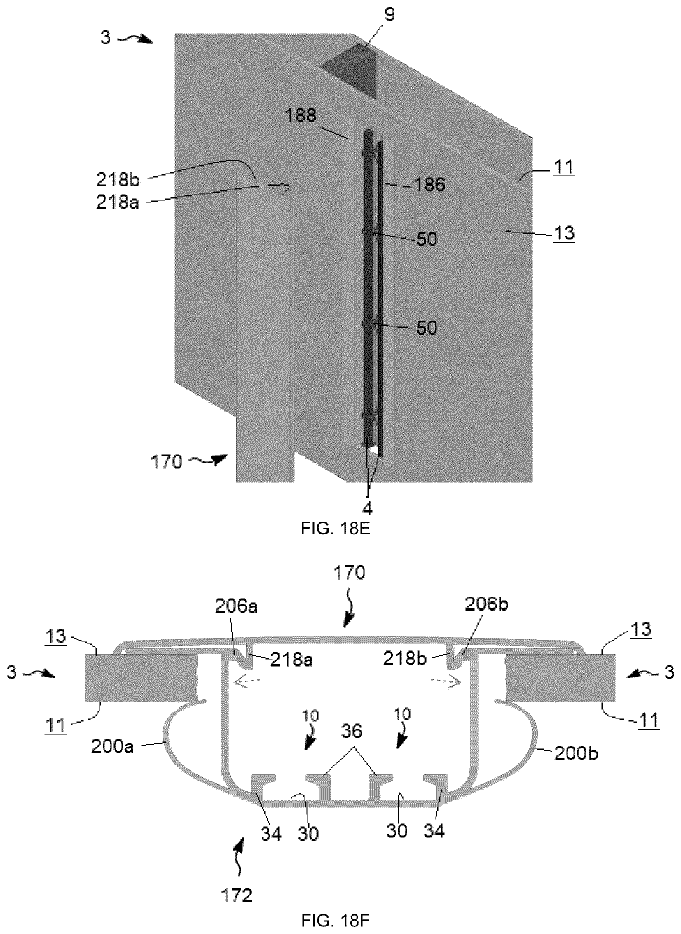

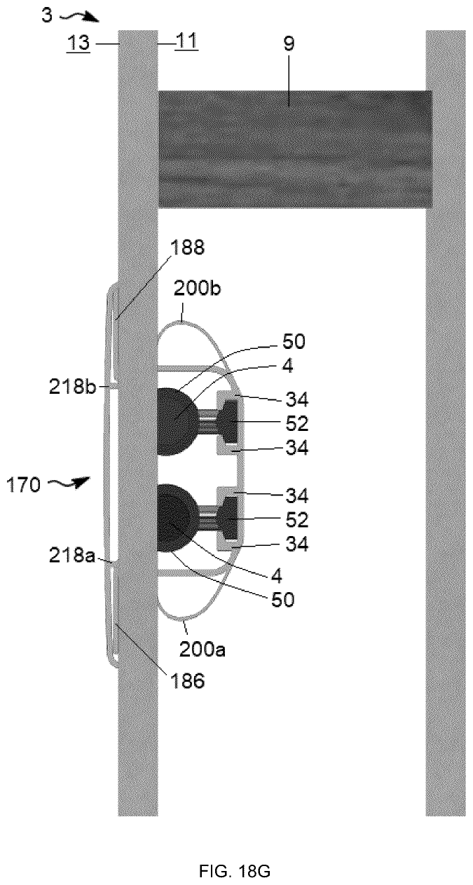

Using the embodiment of FIG. 17F to demonstrate installation, an aperture (8) is cut into the wall (3) proximate to the wall stud (9) inside the wall (3), and allowing sufficient space for insertion of the main portion (168) (FIG. 18A). The first barb (200b) of the main portion (168) is inserted into the aperture (8) to allow the first barb (200b) to flex inwardly (FIG. 18B, shown by arrows), and the second barb (200a) is then snap-fit into the aperture (8) such that the first and second barbs (200b, 200a) flex outwardly (shown by arrows) to rest against the inner surface (11) of the wall (3) and the first and second lateral surfaces (186, 188) rest against the outer surface (13) of the wall (3) (FIG. 18C). As previously described, the track (10) comprises clip-retaining mechanisms for anchoring the plumbing-retaining members (12, clip 12a is shown for example) to the track (10). In some embodiments, the plumbing lines (4), electrical wires, or other utilities are cut to the desired length. The plumbing lines (4), electrical wires, or other utilities are snap fit into the plumbing-retaining members (12) which grip the plumbing lines (4), electrical wires, or other utilities snugly therein (FIG. 18D, shown by arrows).

In some embodiments, the cover (170) is cut to the desired length and aligned with the main portion (168) and pressed thereto (FIG. 18E). When the cover (170) is pressed into the main portion (168), the cover lips (218a, 218b) flex inwardly as they encounter the side lips (206a, 206b). Once the cover lips (218a, 218b) pass the side lips (206a, 206b), the cover (170) returns to its original shape and the cover lips (218a, 218b) snap fit to overlap the side lips (206a, 206b) (see arrows), thus retaining the cover (170) to the main portion (168) (FIGS. 18F-G). The cover (170) can be painted to match the color of the wall (3), thereby concealing the cover (170) for aesthetic purpose.

The particular embodiments disclosed above are illustrative only, as the present disclosure may be modified and practiced in different but equivalent manners apparent to those skilled in the art having the benefit of the teachings herein. While numerous changes may be made by those skilled in the art, such changes are encompassed within the scope of the subject matter defined by the appended claims. Furthermore, no limitations are intended to the details of construction or design herein shown, other than as described in the claims below. It is therefore evident that the particular illustrative embodiments disclosed above may be altered or modified and all such variations are considered within the scope of the present disclosure.

What is claimed is:

1. A cap for a wall comprising upper and lower major surfaces, opposing end surfaces, a first curved lateral surface, a second curved lateral surface, and a pair of opposed flexible fins extending outwardly from the lower major surface for removably securing the cap within the wall.

2. The cap of claim 1, wherein each fin comprises a shank and a curved barb inwardly facing the shank, or integrally connected to the shank.

3. The cap of claim 2, further comprising a bow connected between the shanks.

4. The cap of claim 2, further comprising one or more tracks comprising one or more clip-retaining mechanisms, and extending outwardly from the lower major surface and positioned between the shanks along a length or portion thereof of the lower major surface.

5. The cap of claim 4, wherein the clip-retaining mechanism comprises a groove extending between the opposed end surfaces of the cap, the grooves being defined by a plurality of rails extending outwardly from the lower major surface, each rail being spaced parallel and apart from adjacent rails and defining a pair of rail lips delimiting a slot for removably anchoring a plumbing-retaining member therein.

6. A method for concealing one or more plumbing lines within a wall using the cap of claim 1.

7. A system for routing one or more plumbing lines within a wall comprising the cap of claim 4.

8. The system of claim 7, further comprising one or more plumbing-retaining members configured to grip the one or more plumbing lines and to be removably anchored to the one or more clip-retaining mechanisms of the one or more tracks.

9. The system of claim 8, wherein the plumbing-retaining member comprises a clip having a gripping portion for receiving and gripping the plumbing line, and a mounting portion for removably anchoring to the clip-retaining mechanism.

10. A method of routing one or more plumbing lines within a wall comprising:
removably anchoring one or more plumbing-retaining members configured to grip the one or more plumbing lines to the one or more clip-retaining mechanisms of the cap of claim 4;
partially pulling the one or more plumbing lines through an aperture formed within the wall towards the cap, the one or more plumbing-retaining members gripping the one or more plumbing lines; and
snap-fitting the flexible fins of the cap within the wall to removably secure the cap and the one or more plumbing lines within the wall.

11. A system for routing one or more plumbing lines within a wall comprising:
a main portion comprising one or more tracks comprising one or more clip-retaining mechanisms and a pair of opposed flexible fins for removably securing the main portion within the wall; and
one or more covers configured to be removably secured to the main portion.

12. The system of claim 11, wherein the main portion comprises a base having upper and lower major surfaces, opposing end surfaces, opposed sides, a first lateral surface, a second lateral surface, and the flexible fins extending outwardly from the sides.

13. The system of claim 12, wherein the base supports the one or more tracks comprising the one or more clip-retaining mechanisms for securing one or more plumbing-retaining members configured to grip the one or more plumbing lines and to be removably anchored to the one or more clip-retaining mechanisms.

14. The system of claim 12, wherein the first and second lateral surfaces extend outwardly from the sides and perpendicular to the sides for resting against an outer surface of the wall.

15. The system of claim 12, wherein the flexible fins extend outwardly below the first and second lateral surfaces, the flexible fins being selected from flat or curved fins; fins comprising barbs; or a pair of fins extending upwardly and outwardly from the sides.

16. The system of claim 12, wherein each side comprises a cover-retaining mechanism for removably securing the cover to the main portion.

17. The system of claim 16, wherein the cover-retaining mechanism comprises first and second opposed pairs of top and bottom protrusions which define gaps therebetween for receiving and removably securing the cover, the cover defining notches and curved edges configured to snap fit between the gaps.

18. The system of claim 16, wherein the cover-retaining mechanism comprises opposed side lips defining cover-engaging shoulders for removably securing the cover thereon, the cover defining first and second cover lips defining side lip-engaging shoulders.

19. A method of routing one or more plumbing lines within a wall comprising:
removably securing the main portion of claim 11 within the wall by snap-fitting the flexible fins through an aperture formed within the wall;
removably anchoring one or more plumbing-retaining members configured to grip the one or more plumbing lines to the one or more clip-retaining mechanisms of the one or more tracks;
snap-fitting the one or more plumbing lines to the one or more plumbing-retaining mechanisms; and
removably securing the cover to the main portion.
